(19) United States
(12) Patent Application Publication
(10) Pub. No.: US 2024/0025276 A1
(43) Pub. Date: Jan. 25, 2024

(54) WIRELESS POWER TRANSFER SYSTEM AND METHOD

(71) Applicant: Elssway Ltd Company, Tel Aviv - Jaffe (IL)

(72) Inventor: Asaf Manova ELSSIBONY, Tel Aviv (IL)

(21) Appl. No.: 18/037,738

(22) PCT Filed: Nov. 19, 2021
(86) PCT No.: PCT/IL2021/051384

§ 371 Date: May 18, 2023

Related U.S. Application Data
(60) Provisional application No. 63/116,147, filed on Nov. 19, 2020.

(51) Int. Cl. B60L 53/14; B60L 53/36; H02J 50/80

(52) U.S. Cl. CPC B60L 53/14; B60L 53/36; H02J 50/80

(57) ABSTRACT

Near field spatial conductors' system and method configured to cover relatively large area and volume while maintain high electromagnetic (EM) coupling and high-power transfer efficiency between the transmitter/s and the receiver/s as part of a mobile platform (essentially for transport and locomotion) wireless powering and charging system. A constant and continuous EM coupling between a continuous signal conductor, a continuous ground conductor (both connected to same alternation power source) and a receiving conductor allow a mobile platform to receive a substantially constant stream of power without intervals of resonance and coupling along the path of an arrangement of said conductors.

### FIELD OF THE INVENTION

The present invention generally relates to the field of wireless power transfer (WPT) and, more particularly, to the field of electromagnetic (EM) near-field power systems for mobile platforms.

### BACKGROUND OF THE INVENTION

Wireless charging systems and methods that utilize various types of energy transfer such as magnetic induction, magnetic resonance, RF power transfer, ultrasonic power transfer and light power transmission are known in the art. Said systems and methods usually require proximity and a high degree of alignment between the transmitter and the receiver in order to maintain efficient power transfer within a well-known, limited, well-defined and restricted area or volume.

The above noted known systems and methods are essentially adapted for wireless charging and powering stationary platforms, and are not particularly suitable for powering or charging mobile platforms such as vehicles configured to be operated in either land, sea, air or space and characterized by their ability to be in motion or provide any form of transportation.

Some solutions known in the art (such as U.S. Ser. No. 10/298,058) discuss a WPT architecture directed at dynamic in motion power transfer which is limited to capacitive WPT which require more than one voltage capacity source. Whereas others (such as US2016/0023557) provide solutions which are limited in area of coverage and require complex detection apparatus to identify the locomotor and operate the charging unit. Moreover, said solutions provide punctured and un-continuous charging by using multiple charging pads, wherein, due to physical constrains, are limited to emitting electrical or magnetic fields only within the borders of the dimensions of said charging pads, hence strict and full alignment is required.

Accordingly, there is a need for a single sourced and continuous wireless powering and charging system and method that can cover large area/s and volume/s, not necessarily aligned, while maintaining high, strong, safe, uniform and stable electromagnetic (EM) coupling between the signal and ground conductors (transmitting elements) and the receiving conductor/s (receiving element/s), wherein the receiving element may be in motion relative to the signal and ground conductors.

### SUMMARY OF THE INVENTION

The present invention provides a novel near field spatial conductors system and method configured to cover relatively large area and volume while maintaining high electromagnetic (EM) coupling and high-power transfer efficiency between the transmitter/s and the receiver/s as part of a mobile wireless powering and charging system. According to the invention, a constant and continuous EM coupling between a continuous signal conductor, a continuous ground conductor (both connected to same alternating power source) and a receiving conductor allow a mobile platform to receive a substantially constant stream of power without intervals of resonance and coupling along the path of an arrangement of said conductors.

An additional advantage of the invention is that the relation between the receiver and conductors which enables such uninterrupted substantially constant stream of power without intervals of resonance and coupling enables the mobile platform (wherein said mobile platform may be any type of locomotor/vehicle, either autonomous or controllable, and configured to be operatable above or under the ground, above or under water, in air, space, etc.). Said arrangement is also configurable to be flexible whereby the mobile platform's position and proximity in relation to the transmitting conductors does not require strict alignment with WPT system components.

An additional advantage of the invention is that more than one mobile platform can be powered by same WPT system using same continuous conductors' assembly, at the same time without substantially reducing the performance of the system.

In contrast to the aforementioned prior art, in which both the transmitting and the receiving antennas or coils are designed to have self-resonance in the same frequency in order to achieve high energy transfer efficiency, the spatial resonance system for wireless power transfer according to the invention determines the resonance frequency which is determined and occurs by both transmitting antenna (continuous conductors) and receiving antenna (receiving conductor).

According to one aspect, there is provided a near field power system, comprising: at least one alternating power signal source, at least one continuous signal conductor configured to receive an electrical signal from said power signal source and further configured to be stretched along a path, at least one continuous ground conductor configured to be in communication with a ground of said power signal source and further configured to be stretched along said path, and at least one receiving conductor configured to be mounted on at least one mobile platform, wherein the continuous signal conductor is configured to be disposed in a predefined distance from the continuous ground conductor whereby a designated charging volume is formed and a resonance occurs within said charging volume.

According to some embodiments, the resonance within charging volume designates a constant and continuous EM coupling between the said continuous signal and ground conductors and the receiving conductor.

According to some embodiments, the at least one alternating power signal source is a transmitter configured to generate such signal.

According to some embodiments, the at least one alternating power signal source is in communication with the receiving conductor whereby the function of the other conductors is modified accordingly.

According to some embodiments, the designated distance separating the continuous signal and ground conductors along the path determines the dimensions of the charging volume.

According to some embodiments, the at least one mobile platform is configured to be charged through the receiving conductor by the constant EM coupling creating a wireless charging volume.

According to some embodiments, the at least one mobile platform is stationary within the charging volume.

According to some embodiments, the at least one continuous signal conductor is configured to be placed between at least two continuous ground conductors, and wherein said conductors are configured to be spaced by a designated distance along the path.

According to some embodiments, the at least one continuous signal conductor and the at least one continuous ground conductor are configured to be mounted on ground level.

According to some embodiments, the at least one continuous signal conductor and the at least one continuous ground conductor are configured to be mounted beneath ground level.

According to some embodiments, the at least one continuous signal conductor and the at least one continuous ground conductor are configured to be mounted on a vertical surface.

According to some embodiments, wherein the at least one continuous signal conductor and the at least one continuous ground conductor are configured to be mounted on a moving object.

According to some embodiments, the at least one continuous signal conductor and the at least one continuous ground conductor are configured to be made of a conductive material having a thickness of 50-150 micron.

According to some embodiments, the at least one continuous signal conductor and/or the at least one continuous ground conductor are of an elongated sheet shape.

According to some embodiments, the at least one continuous signal conductor and/or the at least one continuous ground conductor have circular cross-sections.

According to some embodiments, the receiving conductor is mounted on a mobile platform and wherein the receiving conductor is configured to maintain a continuous EM coupling with the at least one continuous signal conductor and the at least one continuous ground conductor during operation or movement along the path.

According to some embodiments, the receiving conductor is mounted on a mobile platform and maintains a constant and continuous EM coupling with the at least one continuous signal conductor and the at least one continuous ground conductor while moving near the path but not necessarily in alignment with the path.

According to some embodiments, the receiving conductor is configured to maintain constant and continuous EM coupling with the at least one continuous signal conductor and the at least one continuous ground conductor as long as it remains within a charging volume.

According to some embodiments, the operational constant and continuous EM coupling is maintained with the at least one continuous signal conductor and the at least one continuous ground conductor by a height control means

According to some embodiments, the at least one receiving conductor may be mounted on any section of the mobile platform.

According to some embodiments, the mobile platform is an autonomous vehicle configured to move along the path.

According to some embodiments, the autonomous vehicle is a logistic vehicle configured to move within an operational environment.

According to some embodiments, the mobile platform is an electrical vehicle (EV) configured to keep full operability while charging.

According to some embodiments, the at least one continuous signal conductor, or the at least one continuous ground conductor are configured to have different dimensions along their length in order to provide adaptive resonance and EM coupling capabilities.

According to some embodiments, the different dimensions are at least one non-parallel section forming a part of the at least one continuous signal conductor and/or the at least one continuous ground conductor.

According to some embodiments, multiple sections of continuous signal conductors and continuous ground conductors are placed in a consecutive manner along the path.

According to some embodiments, the EM resonance is creatable only when a mobile platform having a receiving conductor is present within a designated charging volume.

According to some embodiments, multiple EM resonances are created for each of at least two mobile platforms having a receiving conductor and move along the path.

According to a second aspect, there is provided a method for using a near field power system, comprising the steps of: providing an alternating power signal produced by at least one transmitter, communicating said alternating power signal to at least one continuous signal conductor while the at least one continuous ground conductor is in communication with the transmitter ground, wherein both conductors are configured to be stretched along a path and be disposed in predefined distance from each other, providing at least one receiving conductor configured to be mounted on at least one mobile platform, forming an electromagnetic (EM) resonance between the at least one continuous signal conductor together with at least one continuous ground conductor and the receiving conductor and creating a constant and continuous EM coupling between the continuous signal together with the ground conductors and the receiving conductor.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention.

In the Figures:

FIGS. 1A and 1B constitute schematic views of a continuous conductors' assembly, forming a part of a WPT system, according to some embodiments of the invention.

FIGS. 2A-21I constitute schematic views looking along the conductor's axis line of various configurations of the continuous conductor's assembly, forming a part of a WPT system, according to some embodiments of the invention.

FIGS. 3A and 3B constitute schematic views of various configurations of the continuous conductor's assembly, forming a part of a WPT system, according to some embodiments of the invention.

FIGS. 4A and 4B constitute schematic views of various configurations of the continuous conductors' assembly, forming a part of a WPT system, according to some embodiments of the invention.

FIG. 5 constitutes a schematic view of various configurations of the continuous conductors' assembly, forming a part of a WPT system, according to some embodiments of the invention.

FIG. 6 constitutes a schematic top view of various configurations of the continuous conductor's assembly which schematically illustrates various possible relations between the continuous conductors forming the continuous conductor's assembly and the identification of such components, according to some embodiments of the invention.

FIGS. 7A and 7B constitute schematic views of the mobile platform containing a receiving conductor forming a part of the WPT system, according to some embodiments of the invention.

FIG. 7C constitutes a schematic view of the receiving conductor forming a part of the WPT system, according to some embodiments of the invention.

FIGS. 8A and 8B constitute schematic views of the WPT system, according to some embodiments of the invention.

FIGS. 9A and 9B constitute schematic perspective views of the WPT system, according to some embodiments of the invention.

FIG. 10-13 depict EM fields' cross section High Frequency Simulation Software (HFSS) results in various parameters and relations of the WPT system, according to some embodiments of the invention.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “controlling” “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, a cloud computing system or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform or component that may be provisioned with a Central Processing Unit (CPU) or microprocessors, and may be provisioned with several input/output (I/O) ports, for example, a general-purpose computer such as a personal computer, laptop, tablet, mobile cellular phone, controller chip, SoC or a cloud computing system.

The term “Charging volume”, as used herein, refers to the potential extent of an EM resonance between two conductors. For example, the charging volume may be the potential extent in which an EM resonance may cause an EM coupling between a transmitting and a receiving conductor.

The term “Continuous signal conductor”, as used herein, refers to a conductor configured to be in communication with a transmitter output and receives a continuous and substantially uninterrupted alternating power signal.

The term “Continuous ground conductor”, as used herein, refers to a conductor configured to be in communication with a transmitter's ground.

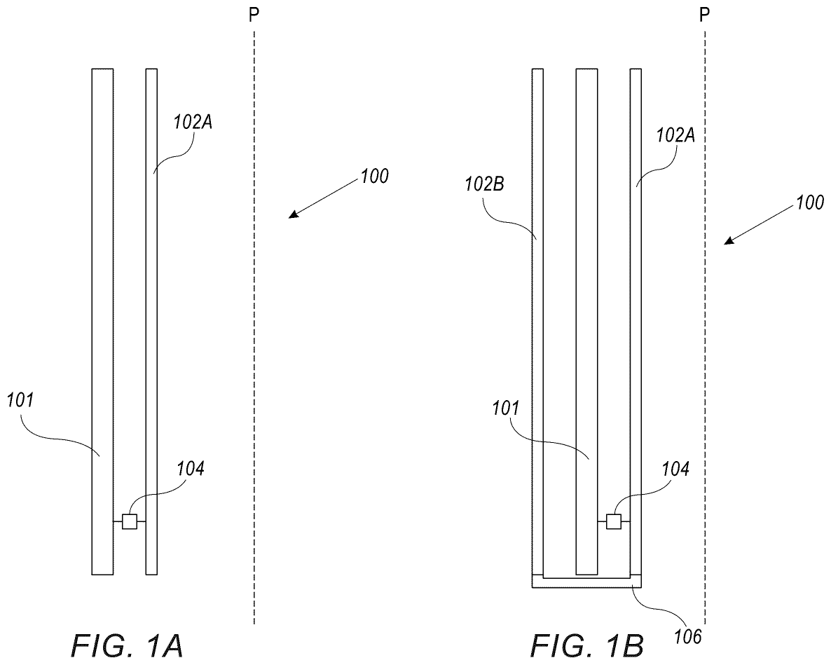

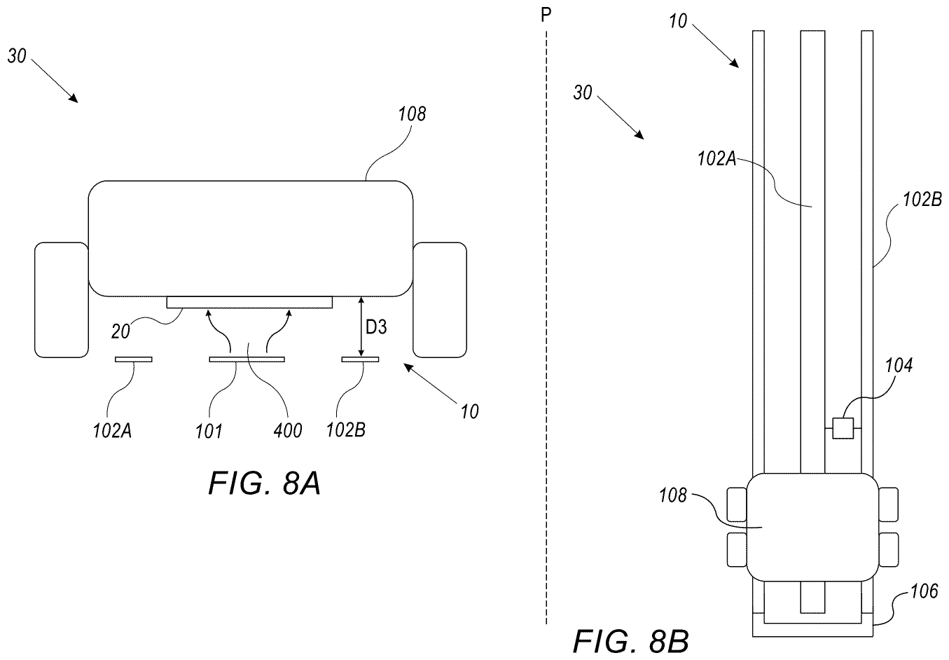

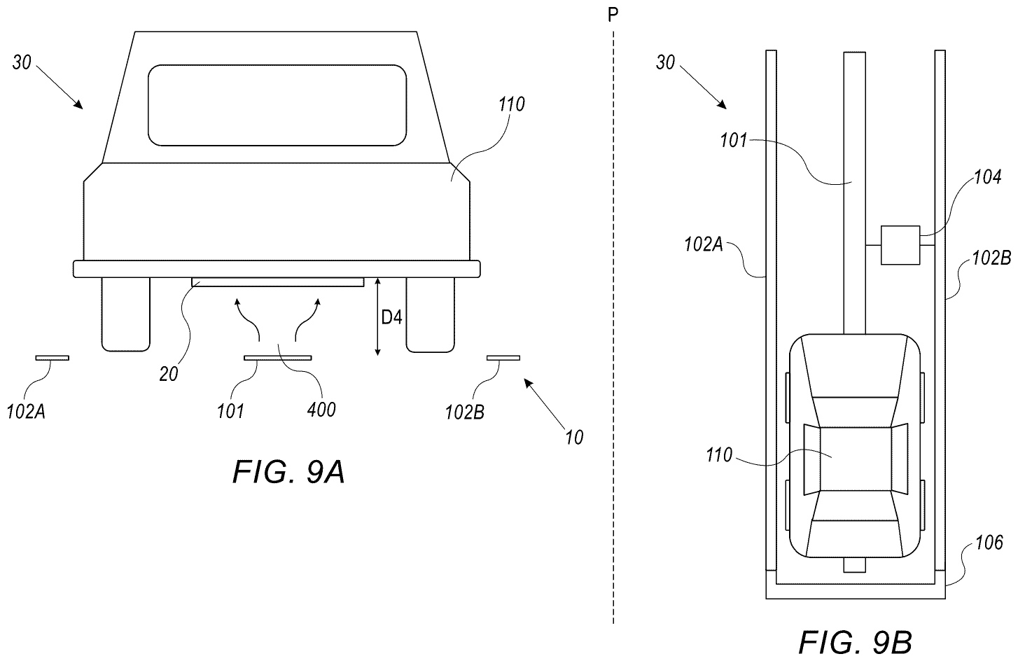

Reference is now made to FIGS. 1A and 1B which schematically illustrate a continuous conductors' assembly 10, forming a part of a WPT system 30 (shown in FIGS. 8 and 9). As shown, at least one continuous signal conductor 101 is configured to radiate an electromagnetic field and further configured to be dispersed along a path P. According to some embodiments, continuous signal conductor 101 is configured to be connected to a transmitter 104 that may be located anywhere along the length of signal conductor 101.

According to some embodiments, at least one continuous ground conductor 102 is configured to be placed in proximity to the continuous signal conductor 101 and also be connected to the ground of transmitter 104. According to some embodiments, at least one continuous ground conductor 102 is configured to be placed in parallel to the continuous signal conductor 101.

According to some embodiments, continuous signal conductor 101 and continuous ground conductor 102 are configured to be connected to transmitter 104 that produces an alternating power signal, and further configured to create a resonance designated to create a constant and continuous EM coupling between the continuous signal conductor 101 together with the continuous ground conductor 102, and the receiving conductor (depicted in FIGS. 8 and 9).

According to some embodiments, said capability allows a mobile platform to receive a substantially constant wireless transfer of power without intervals of changes in the resonance which may lead to uncoupled conditions between conductors' assembly 10 and the receiving conductor (depicted in FIGS. 8 and 9). According to some embodiments, the said connection of continuous signal conductor 101 and continuous ground conductor 102 with transmitter 104 may be any form of radiation communication.

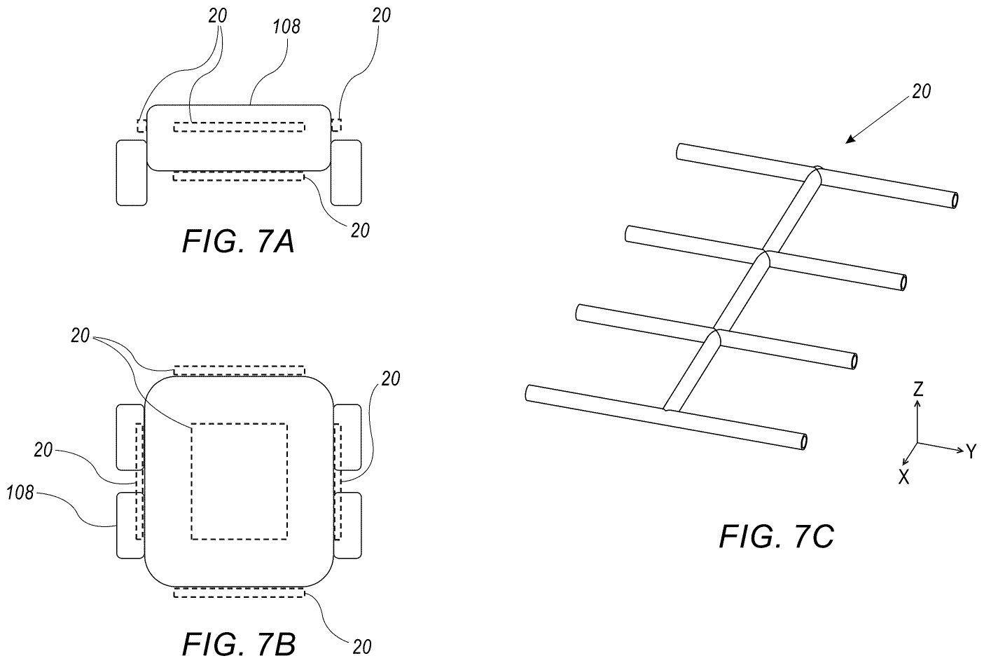

According to some embodiments, at least two continuous ground conductors 102A and 102B are configured to be placed in proximity to the continuous signal conductor 101 and further configured to create a resonance designated to create a constant and continuous EM coupling between the continuous signal conductor 101, the at least two continuous ground conductor 102A and 102B and the receiving conductor (depicted in FIG. 7), allowing a mobile platform to receive a constant stream of power without intervals of changes in the resonance which may lead to uncoupled conditions between conductors' assembly 10 and the receiving conductor.

According to some embodiments, at least one continuous ground conductor 102 is configured to be placed in parallel to the continuous signal conductor 101. According to some embodiments, continuous ground conductor 102A and 102B may be connected by a conductive connection 106 in order to provide the same reference level in the electrical circuit formed by the continuous conductors' assembly 10. According to some embodiments said reference point is obtained by an electric grounding means.

According to some embodiments, continuous conductors' assembly 10 is configured to define the covered volume of WPT system 30 and also configured to maintain the same resonating and coupling performance, for a predefined frequency, in any point within the designated volume with the receiving conductor of WPT system 30.

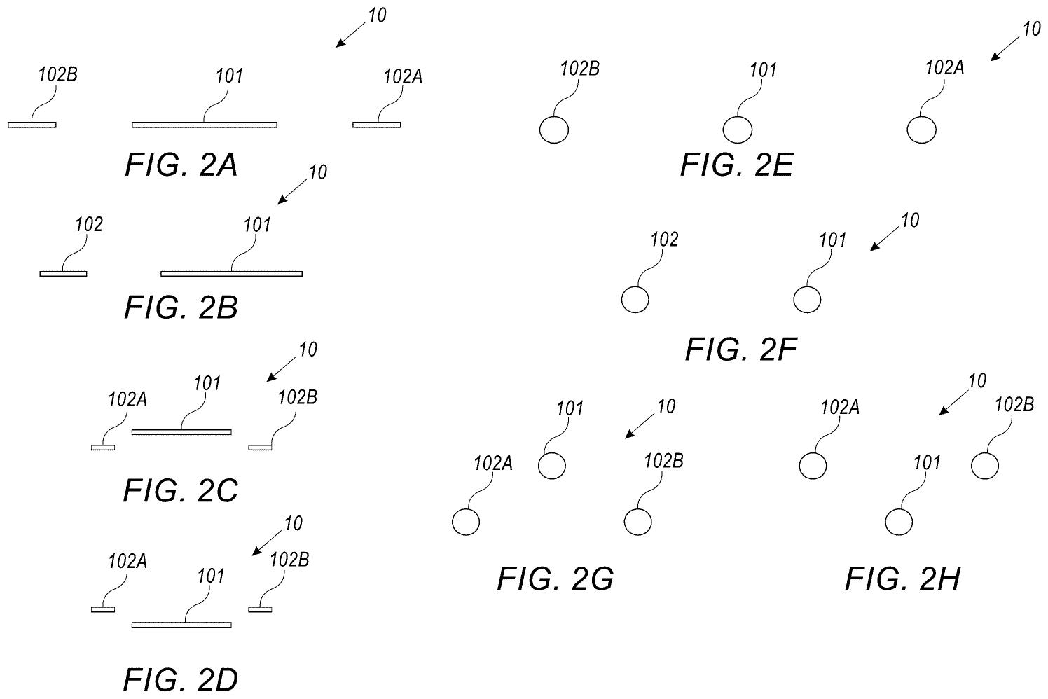

Reference is now made to FIGS. 2A-21I which schematically illustrate various configurations of the continuous conductor's assembly 10, forming a part of a WPT system 30. As shown, continuous signal conductor 101, and/or continuous ground conductor 102 and/or the at least two continuous ground conductor 102A and 102B may have various dimensions, cross sections, heights and forms. For example, said conductors may be in the form of a thin sheet, preferably in the thickness of 50-150 micron. In another example, said conductors may have a circular cross section, etc.

According to some embodiments, the creation of the potential designated charging volume wherein resonance may occur for various configurations of the continuous conductor's assembly 10, forming a part of a WPT system 30 represents the potential distribution of EM field of various conductors forming the conductor's assembly 10. The potential EM field distribution sets the dimensions of the potential charging volume with respect to the forming of the conductor's assembly 10.

According to some embodiments, the various configurations and shapes of the continuous conductor's assembly 10 which has an effect on the charging volume of the EM resonance created between and as a consequence of, has an effect on the EM coupling created between the continuous conductor's assembly 10 and the receiving conductor. According to some embodiments, the configuration, disposition, heights and shapes of the continuous conductor's assembly 10 may be optimized in order to achieve an optimized EM coupling and as a result, an optimized wireless power transfer. According to some embodiments, the designated charging volume may exceed the dimension of the forming of the conductors' assembly 10.

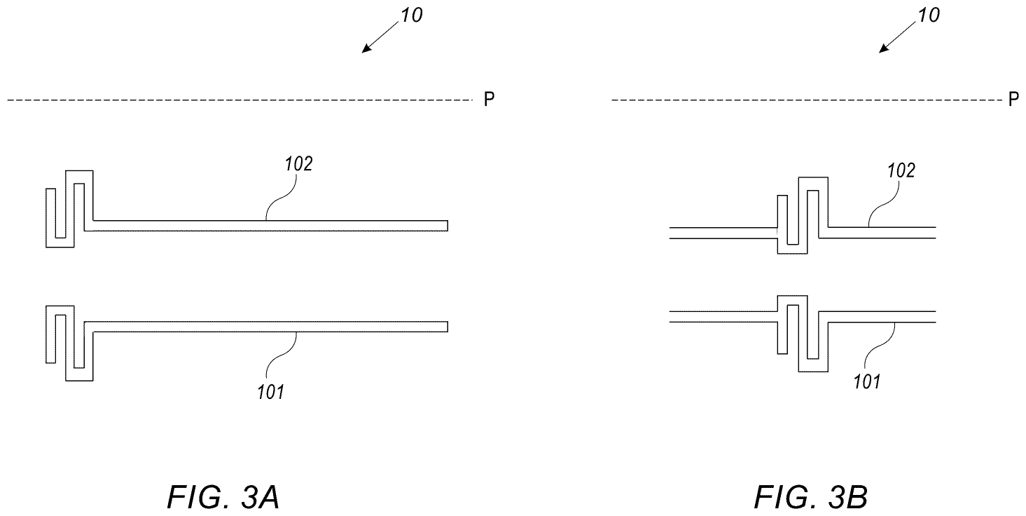

Reference is now made to FIGS. 3A and 3B which schematically illustrate various configurations of the continuous conductor's assembly 10, forming a part of a WPT system 30. As shown, continuous signal conductor 101, and/or continuous ground conductor 102 may be configured to be disposed generally along path P. However, and according to some embodiments, the placement/disposition of said conductors may be adaptable to various constraints or concerns. For example, the placement/disposition of said conductors in certain point/s along the path may be misaligned or perpendicular with regard to path P. According to some embodiments, said displacement flexibility allows disposing said conductors in a varied terrain such as curved or windy roads, etc.

According to some embodiments, said displacement flexibility further allows maintaining continuance resonance and coupling capabilities between conductors' assembly 10 and the receiving conductor. According to some embodiments, the displacement flexibility may change the coupling and resonance performance in a certain point or area within the designated volume of WPT system 30 along path P.

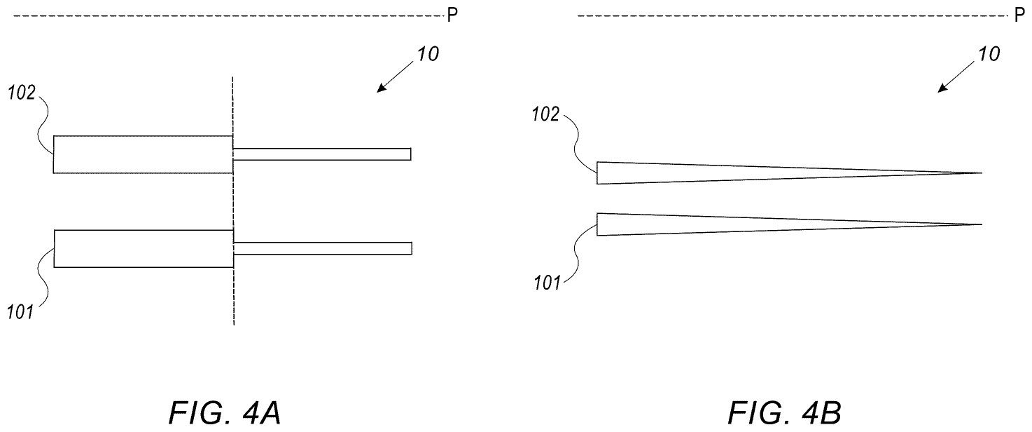

Reference is now made to FIGS. 4A and 4B which schematically illustrate various configurations of the continuous conductors' assembly 10, forming a part of a WPT system 30. As shown, continuous signal conductor 101, and/or continuous ground conductor 102 and/or the at least two continuous ground conductor 102A and 102B may be configured to be disposed generally along path P, however, and according to some embodiments, the width and shape of said conductors may vary in accordance to various constraints or concerns. For example, said conductors may be wider or narrower along their axis, etc. According to some embodiments, said varying width may affect the coupling and resonance performance over a larger and continued area within the designated volume of WPT system 30.

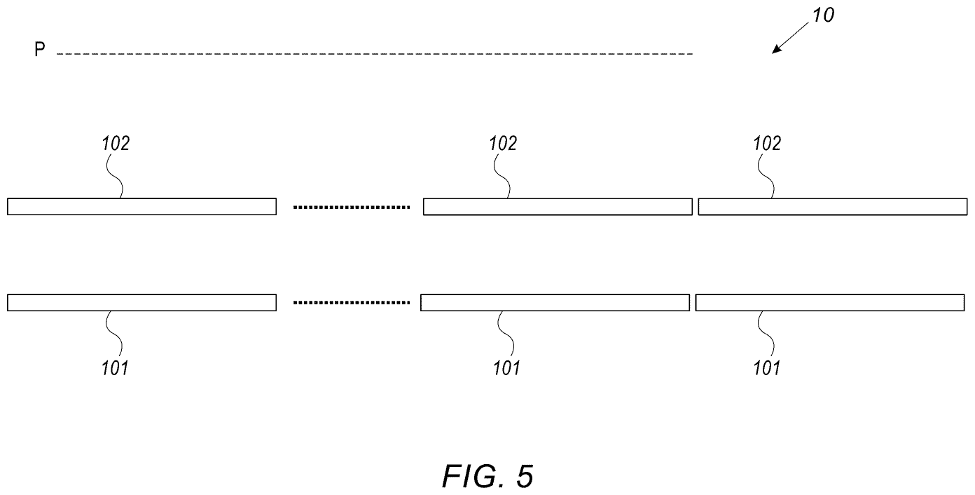

Reference is now made to FIG. 5 which schematically illustrates various configurations of the continuous conductors' assembly 10, forming a part of a WPT system 30. As shown, multiple sections of continuous signal conductor 101, and/or continuous ground conductor 102 may be disposed in a consecutive manner along path P. For example, said conductors may be disposed in several sections configured to be connected and operated as a continuous one unit along path P. According to some embodiments, each section may comprise a separate transmitter 104 configured to individually provide an alternating power signal to each section along path P. According to some embodiments, the consecutive sections may be serial or may be different from one another in accordance with various needs and constrains.

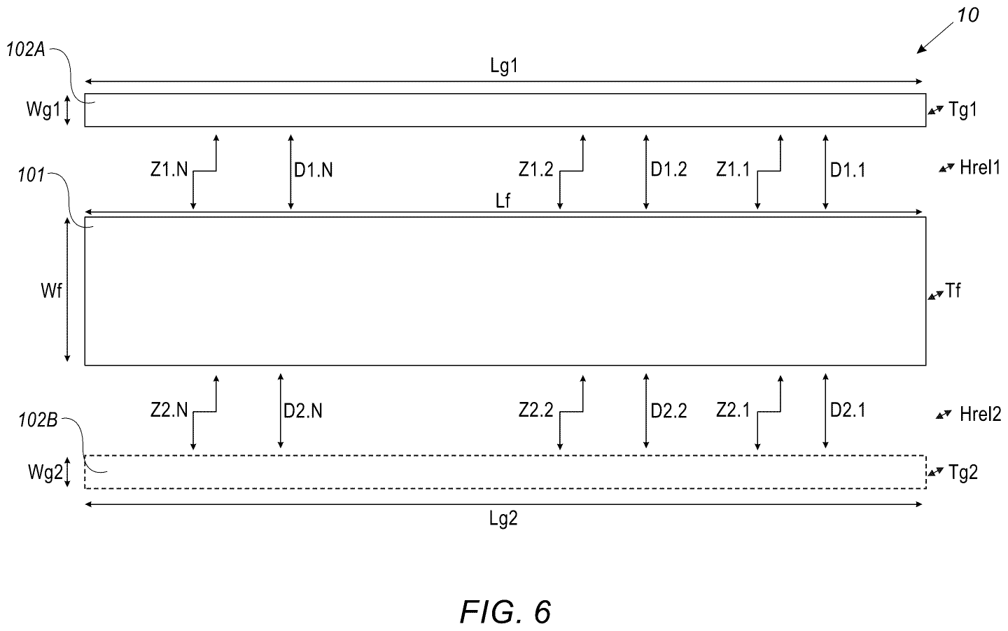

Reference is now made to FIG. 6 which schematically illustrates various possible relations between the conductors forming the continuous conductors' assembly 10 and the identification of such components, wherein:
Wf—continuous signal conductor 101 width.
Lf—continuous signal conductor 101 length.
Tf—continuous signal conductor 101 thickness.
Wg1—continuous ground conductor 102A width.
Lg1—continuous ground conductor 102A length.
Tg1—continuous ground conductor 102A thickness.
Wg2—continuous ground conductor 102B width.
Lg2—continuous ground conductor 102B length.
Tg2—continuous ground conductor 102B thickness.
D1.1; D1.N—the distance between continuous signal conductor 101 and continuous ground conductor 102A.
D2.1; D2.N—the distance between continuous signal conductor 101 and continuous ground conductor 102B.
Hrel1.1; Hrel1.N—the relative height between continuous signal conductor 101 and continuous ground conductor 102A.
Hrel2.1; Hrel2.N—the relative height between continuous signal conductor 101 and continuous ground conductor 102B.
Z1.1-Z1.N—the impedance between continuous signal conductor 101 and continuous ground conductor 102A, that may be achieved by using lump components, stubs, different medium (material), etc.
Z2.1-Z2.N—the impedance between continuous signal conductor 101 and continuous ground conductor 102B, that may be achieved by using lump components, stubs, different medium (material), etc.

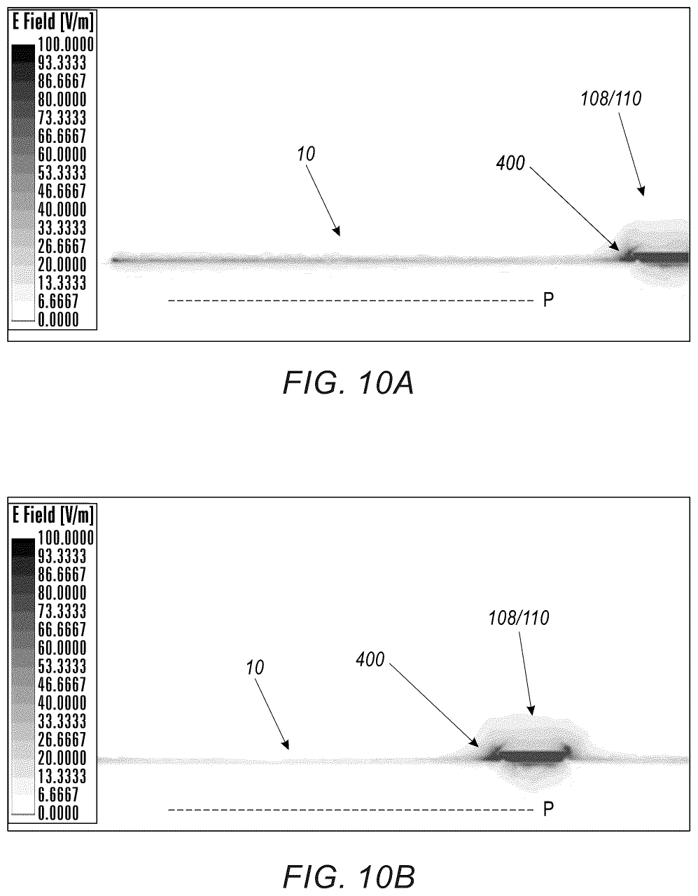

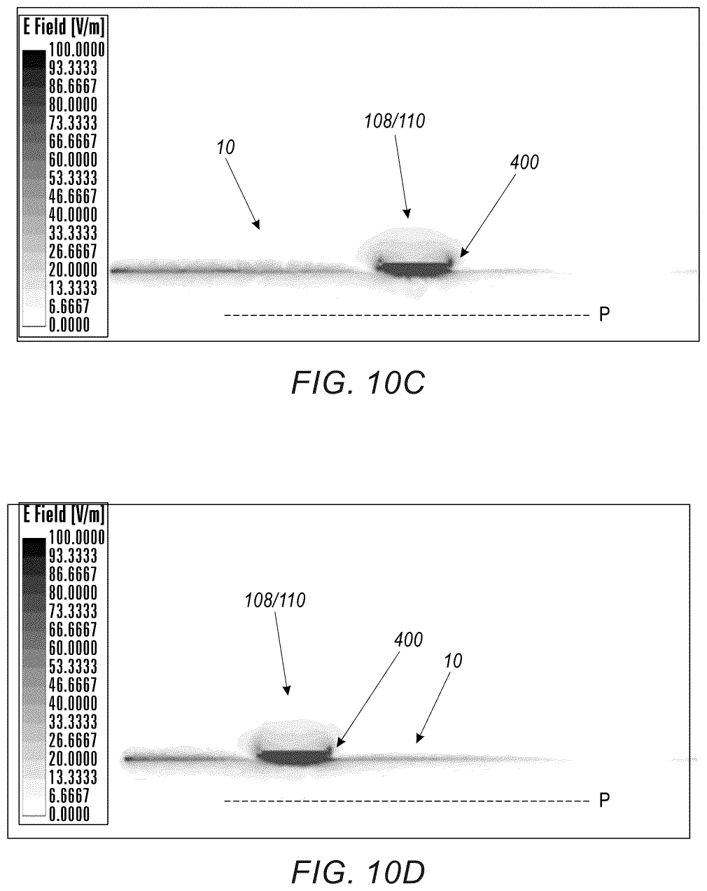

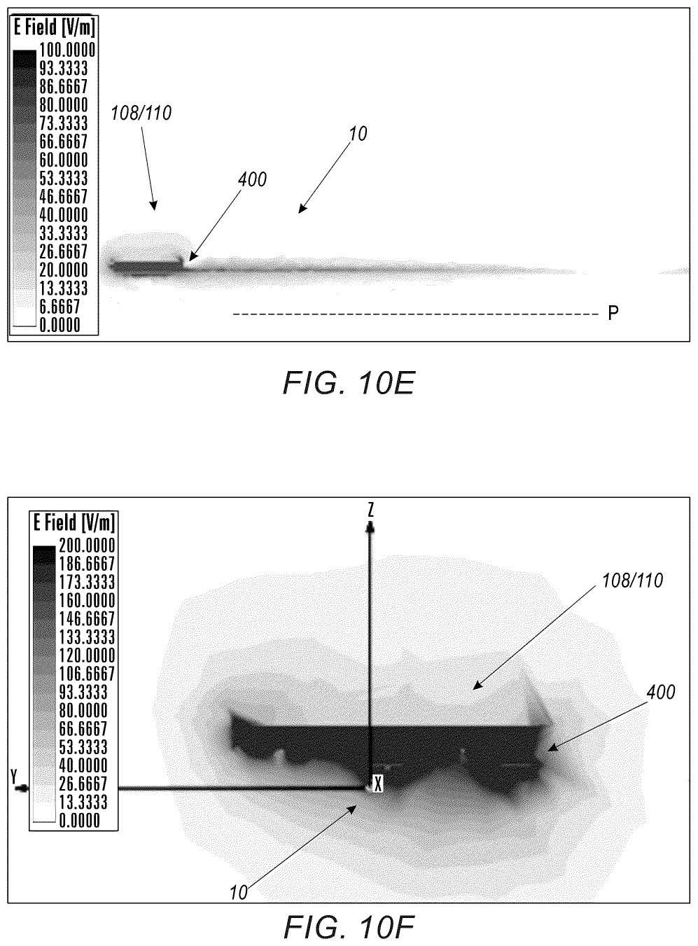

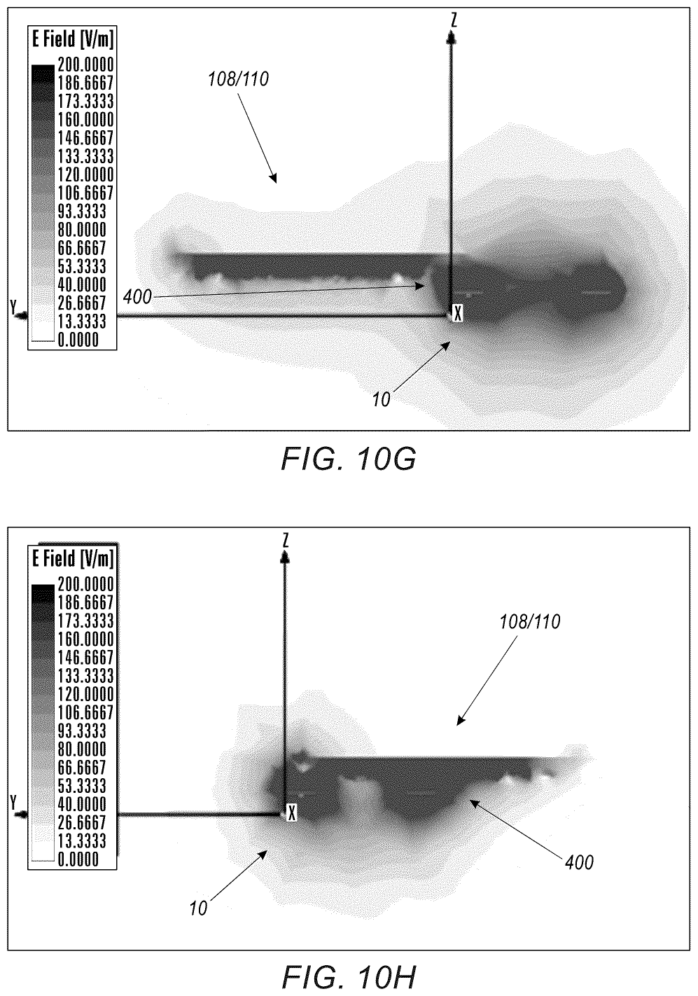

According to some embodiments, the relations between the various conductors forming continuous conductor's assembly 10 may set and define the designated charging volume borders and the required frequencies and constant spatial electromagnetic resonance performance determining the operation of the WPT system 30. (Further examples to said relations and their effects are broadly disclosed and depicted in FIGS. 10-13).

Reference is now made to FIGS. 7A and 7B which schematically illustrate the receiving conductor 20 and the mobile platform 108 forming a part of the WPT system 30. As shown, receiving conductor 20 may be configured to be mounted on a mobile platform 108. According to some embodiments, mobile platform 108 may be any type of locomotor and or vehicle used for any type of transportation or movement within any type of medium, either on/below ground, on/below water, air or space, etc. that is configured to move along a path P (not shown).

According to some embodiments, receiving conductor 20 is configured to function as a complementary subsystem to conductors' assembly 10 whereby receiving conductor 20 and conductors' assembly 10 are arranged to create a continuous spatial resonator wherein receiving conductor 20 is located within the designated volume designated by conductors' assembly 10. According to some embodiments, receiving conductor 20 may be mounted on any surface of the mobile platform 108, for example, receiving conductor 20 may be mounted on the rear, front, ventral or dorsal surfaces of the mobile platform 108, etc. According to some embodiments, such mounting may affect some of the values of the parameters articulated in FIG. 6. It being appreciated that according to some embodiments, while transmitter 104 can be in communication with assembly 10 it may alternatively be in communication with receiving conductor 20, thereby obtaining similar operation of system.

According to some embodiments, receiving conductor 20 may be further connected to a receiving unit that is used to rectify the receiving power to a DC power available for the various uses by the mobile platform 108 (not shown). According to some embodiments, the constant received and rectified EM power may be configured to charge a power banks of the mobile platform 108, for example, the constant received and rectified EM power may be configured to charge a battery, such as a lithium-ion battery, designated to provide propulsion and control to the mobile platform 108.

According to some embodiments, the constant received and rectified EM power may be configured to directly propel and control the mobile platform 108 without the need to use a battery.

According to some embodiments, mobile platform 108 is configured to be fully operatable while moving along the path P, for example, mobile platform 108 may be an electrical vehicle configured to carry passengers, cargo, etc.

Reference is now made to FIG. 7C which schematically illustrate possible configuration of the receiving conductor 20 forming a part of the WPT system 30. As shown, receiving conductor 20 may be formed in various shapes and sizes, or may include various inner/outer conductors, for example, receiving conductor 20 may formed as a ladder-like conductor configured to provide enhanced EM coupling capabilities. According to some embodiments, receiving conductor 20 may be formed as a low-profile conductor.

Reference is now made to FIGS. 8A and 8B which schematically illustrate the WPT system 30. As shown, receiving conductor 20 may be configured to be mounted on a mobile platform 108, which is further configured to move along continuous conductors' assembly 10. According to some embodiments, mobile platform 108 may be a locomotor such as an autonomous robot designated to carry passengers/cargo or perform a certain task. According to some embodiments, mobile platform 108 coupled with receiving conductor 20 is designated to travel/locate within the pre-defined charging volume.

According to some embodiments, EM field distribution 400, represent high EM coupling, occurs when vehicle 108 that comprises receiving conductor 20 enters to the designated charging volume, and wherein the electromagnetic fields generated by conductors' assembly 10 are received by receiving conductor 20, due to occurrence of spatial resonance condition. According to some embodiments, a distance D3 may be derived from the height of the mobile platform 108.

Reference is now made to FIGS. 9A and 9B which schematically illustrates the WPT system 30. As shown, receiving conductor 20 may be configured to be mounted on a mobile platform 110, which is further configured to move along continuous conductor's assembly 10. According to some embodiments, mobile platform 110 may be a vehicle designated to carry passengers or cargo. According to some embodiments, mobile platform 110 coupled with receiving conductor 20 is designated to travel/locate within the range of the pre-defined charging volume. According to some embodiments, an EM coupling 400 occurs when vehicle 108 that comprises receiving conductor 20 is entering the designated charging volume.

According to some embodiments, a distance D4 may be derived from the height of the mobile platform 110. According to some embodiments, mobile platform 110 coupled with the receiving conductor 20 may have adaptive height capabilities in order to achieve optimized EM field distribution 400, represent a high EM coupling.

Reference is now made to FIGS. 10A-10E which schematically illustrates EM field distribution 400, represents a high EM coupling, cross section High Frequency Simulation Software results in various parameters and relations of the WPT system 30. As shown, mobile platform 108/110 fitted with the receiving conductor 20 (not shown) is sampled in several locations, within the designated charging volume, while advancing along (as a shift along the X axis), the conductor's assembly 10 displaced along path P, and while keeping spatial resonance and continuous EM coupling. According to some embodiments, the occurrence of the spatial resonance results in constant and continuous high EM coupling conditions and high-power transfer efficiency, and may be observed by the changing field distribution 400, represent a high EM coupling, that “follows” the location of the receiving conductor 20 within the designated charging volume.

According to some embodiments, in FIG. 10A, mobile platform 108/110 fitted with the receiving conductor 20 is at a distance 0 mm from the beginning of measured conductor's assembly 10, in FIG. 10B, mobile platform 108/110 fitted with the receiving conductor 20 is at a distance 1000 mm from the beginning of measured conductor's assembly 10, in FIG. 10C, mobile platform 108/110 fitted with the receiving conductor 20 is at a distance 2000 mm from the beginning of measured conductor's assembly 10, in FIG. 10D, mobile platform 108/110 fitted with the receiving conductor 20 is at a distance 3000 mm from the beginning of measured conductor's assembly 10 and in FIG. 10E, mobile platform 108/110 fitted with the receiving conductor 20 is at a distance 4000 mm from the beginning of measured conductor's assembly 10. As shown, the high EM coupling and the high-power transfer efficiency are constant and continuous in any location along path P.

Reference is now made to FIGS. 10F-10H which schematically illustrates EM field distribution 400, represent a high EM coupling, cross section High Frequency Simulation Software results in various parameters and relations of the WPT system. As shown, mobile platform 108/110 fitted with the receiving conductor 20 (not shown) is sampled in several locations, within the designated charging volume, while not aligned with the center line of conductor's assembly 10 (represented as a shift along the Y axis), and while keeping spatial resonance and continuous EM coupling.

According to some embodiments, FIG. 10F, depicts mobile platform 108/110 fitted with the receiving conductor 20 and disposed above the center line of conductor's assembly 10. (i.e Y axis distance=0 mm). According to some embodiments, FIG. 10G, depicts mobile platform 108/110 fitted with the receiving conductor 20 and disposes to the left of the center line of conductor's assembly 10 (i.e Y axis distance=250 mm). According to some embodiments, FIG. 1011, depicts mobile platform 108/110 fitted with the receiving conductor 20 and disposes to the right of the center line of conductor's assembly 10 (i.e Y axis distance=−250 mm).

According to some embodiments, mobile platform 108/110 fitted with the receiving conductor 20 is configured to be disposed within the designated volume created by the conductor's assembly 10, WPT system 30 is configured to start resonating in a designated frequency, which leads to the emergence of EM field 400 radiating form conductor's assembly 10 and received by receiving conductor 20 creating high EM coupling. It being appreciated that such WPT system 30 arrangement with receiving conductor 20 contributes to the containment and control of the dispersion of radiation which is delimited by system 20.

As can be seen in FIGS. 10A-10H, WPT system 30 enables maintaining sufficient and continuous EM resonance and coupling regardless of the location of receiving conductor 20 relatively the conductor's assembly 10. According to some embodiments, and as can be seen from the drawings, the EM field 400 emerging from conductor's assembly 10 is mainly distributed and mostly received by receiving conductor 20.

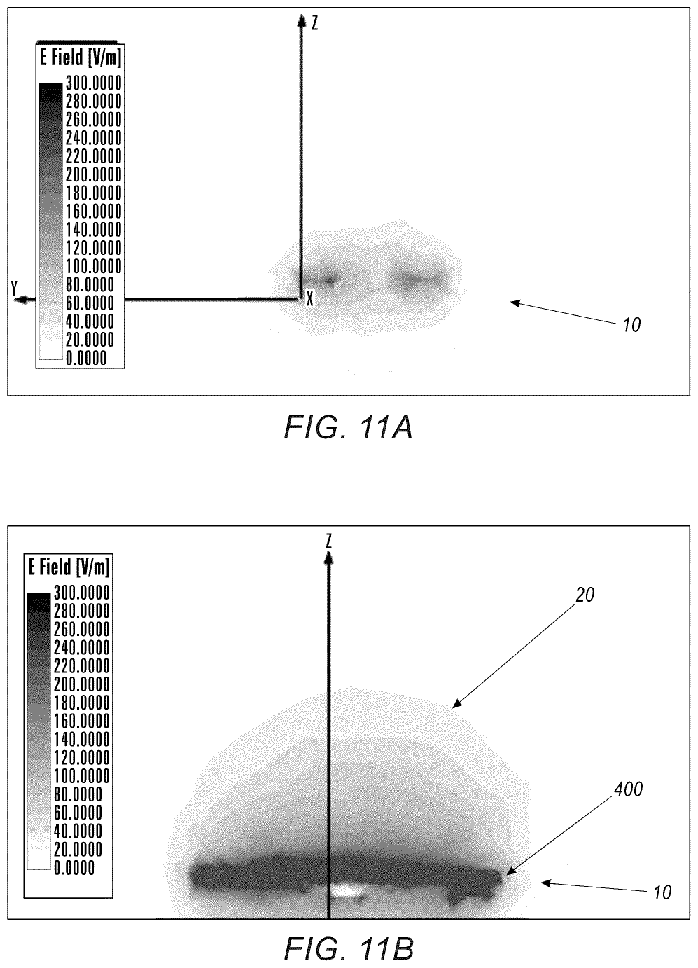

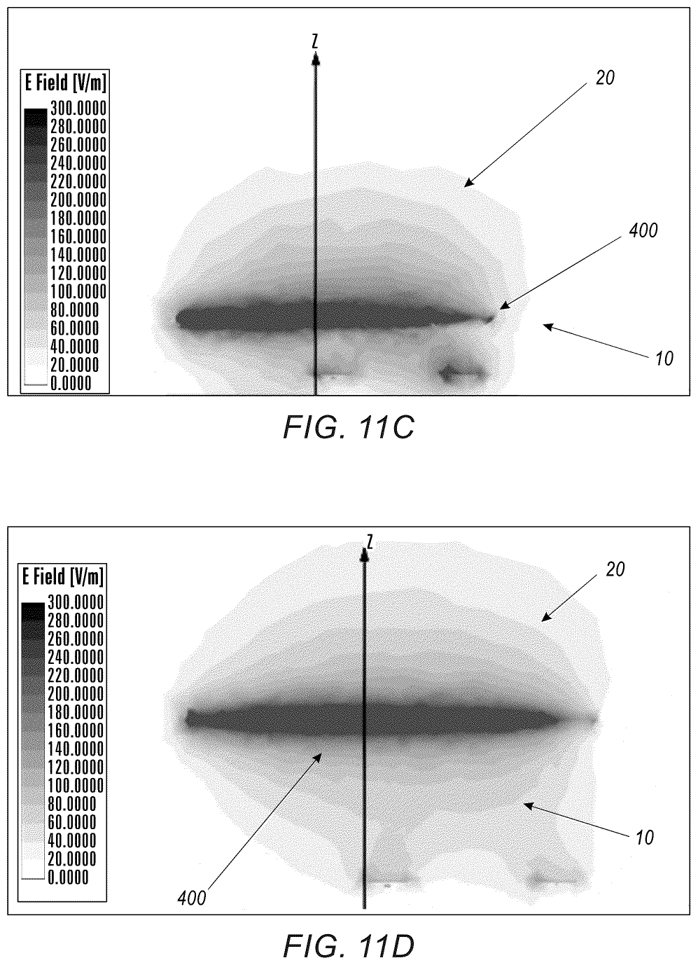

Reference is now made to FIGS. 11A-11D which schematically illustrates EM field distribution 400, represent a high EM coupling, cross section High Frequency Simulation Software results in various parameters and relations of the WPT system 30. As shown,

According to some embodiments, FIG. 11A depicts conductor's assembly 10 without the presence of receiving conductor 20. As shown, conductor's assembly 10 is not resonating due to the absence of receiving conductor 20 within the designate volume.

According to some embodiments, FIG. 11B depicts receiving conductor 20 in an approximate height of 35 mm above conductor's assembly 10. According to some embodiments, said height is an approximate height of an operational robotic mobile platform from the ground.

According to some embodiments, FIG. 11C depicts receiving conductor 20 in an approximate height of 100 mm above conductor's assembly 10. According to some embodiments, said height is an approximate height of an autonomous forklift mobile platform from the ground.

According to some embodiments, FIG. 11D depicts receiving conductor 20 in an approximate height of 200 mm above conductor's assembly 10. According to some embodiments, said height is an approximate height of an electric vehicle from the ground.

As can be seen in FIGS. 11A-11D, WPT system 30 enables maintaining sufficient and continuous EM resonance and coupling regardless of the height (Z axis) of receiving conductor relatively the conductor's assembly 10. According to some embodiments, and as can be seen from the drawings, the EM field 400 emerging from conductor's assembly 10 is mainly distributed and mostly received by receiving conductor 20.

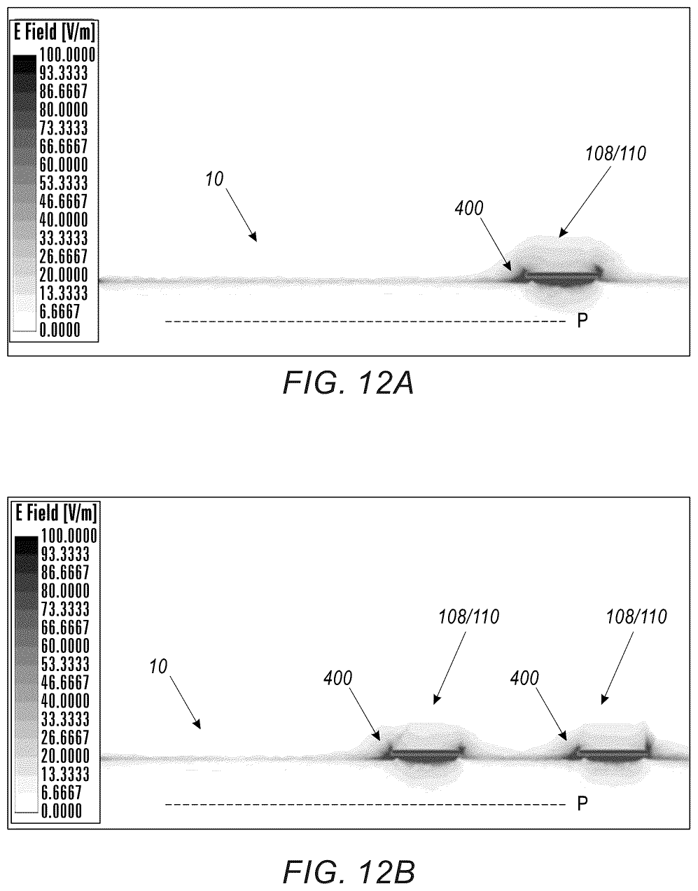

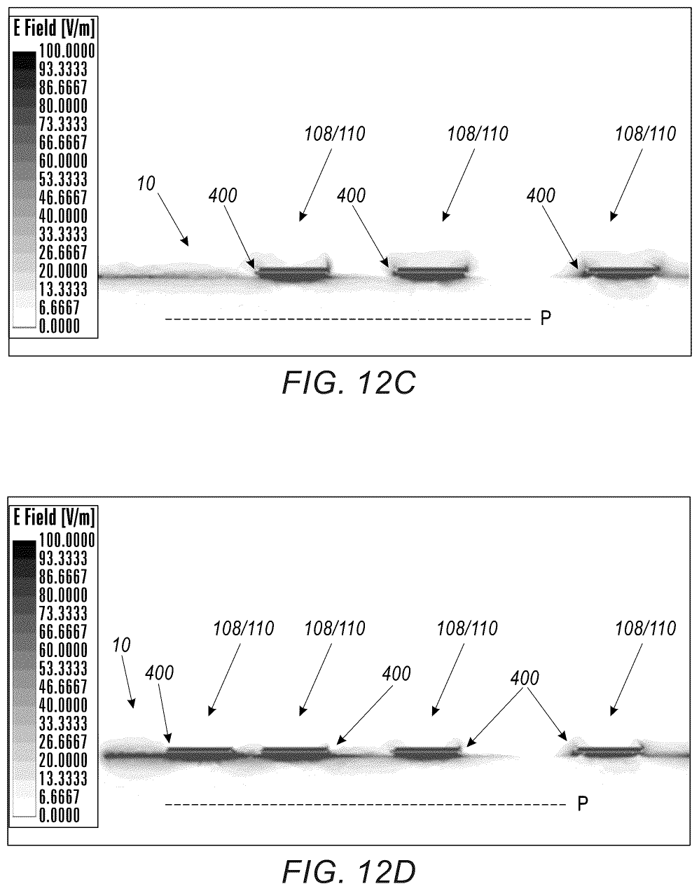

Reference is now made to FIGS. 12A-12D which schematically illustrates EM field distribution 400, represent a high EM coupling, cross section High Frequency Simulation Software results in various parameters and relations of the WPT system 30. As shown, EM coupling is created between the conductors' assembly 10 and each mobile platform 108/110 fitted with the receiving conductor 20 that moves along the path P while each receiving conductors 20 is resonating with conductor's assembly 10 at the same frequency. According to some embodiments, multiple mobile platforms 108/110 may move along the path P and be coupled to conductor's assembly 10 at the same time. According to some embodiments, multiple mobile platforms 108/110 are evenly coupled to conductors' assembly 10 at the same frequency, meaning that the total electromagnetic power transferred from conductors' assembly 10 is equally divided between the mobile platforms 108/110, while the power transfer efficiency between each of mobile platform 108/110 remains high regardless to the number of the additional mobile platform 108/110 locates within the designated volume.

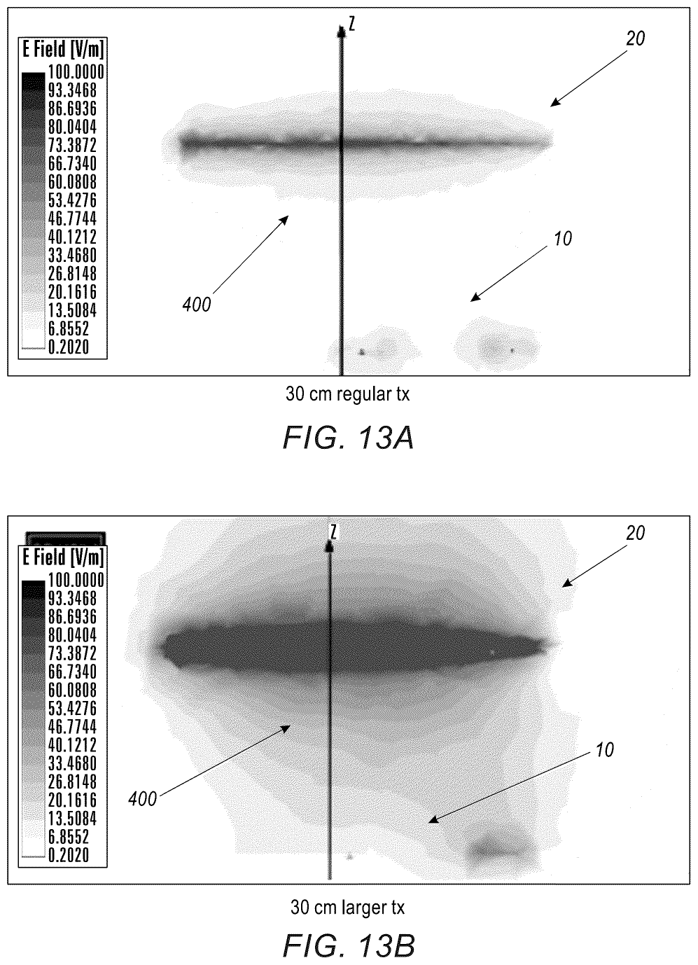

Reference is now made to FIGS. 13A and 13B which schematically illustrates EM field distribution 400, representing EM coupling, cross section High Frequency Simulation Software results in various parameters and relations of the WPT system 30. As shown, FIG. 13A depicts a simulation result of a coupled conductors' assembly 10 and a receiving conductor 20 preferably mounted on a mobile platform. According to some embodiments, the distance between conductor's assembly 10 and receiving conductor 20 on the Z axis is 300 mm. and as a result, reduced coupling occurs in comparison to the strong coupling that occurs in FIG. 13B that also depicts a distance between conductor's assembly 10 and receiving conductor 20 on the Z axis of 300 mm. According to some embodiments, FIG. 13B depicts conductor's assembly 10 having a width (Wf) from closer to 200 mm, resulting extending of the charging volume dimensions and by that maintaining a higher coupling condition, wherein the width (Wf) of the conductors' assembly depicted in FIG. 13A is closer to 50 mm, resulting in lower coupling. As a result, the location of receiving conductor 20 is exceeding the charging volume dimension as depicted in FIG. 13A.

According to some embodiments, conductor's assembly 10 simulation setup numerals are:
continuous signal conductor 101—Lf (length)=4500 mm; Wf (width)=50 mm; Tf (thickness)=0.1 mm; material=copper.
continuous ground conductor 102—Lg1 (length)=4500 mm; Wg1 (width)=50 mm; Tg1 (thickness)=0.1 mm; material=copper. The distance D1 is 170 mm and Hrel1 (the relative height between continuous signal conductor 101 and continuous ground conductor 102) is 0 mm.

According to some embodiments, receiving conductor 20 simulation setup numerals are:
Length of main pole=500 mm; width (side pole length)=350 mm; thickness=10 mm material=copper. According to some embodiments, the simulated WPT system 30 is configured to resonate in the frequency of 13.56 MHz (all simulation results are in the same frequency).

According to some embodiments, the presence or absence of conductor's assembly 10 and receiving conductor 20 may affect the return loss. In other words, conductor's assembly 10 will only resonate, at the desired resonance frequency of system 30, with the presence of receiving unit 20 within the designated charging volume, and vice versa.

According to some embodiments, conductor's assembly 10, may be configured to be assembled above, within or beneath roads, paths, sidewalks, warehouses, aisles, interior and exterior floors, etc.

According to some embodiments, conductor's assembly 10, may be configured to be assembled on vertical surfaces, for example on walls, storage shelves and either on interior or exterior structures, in any transportation medium etc.

According to some embodiments, conductor's assembly 10, may have different impedance levels along the path P.

According to some embodiments, WPT system 30 is a non-radiative system, meaning that minimal radiation is radiated to the surroundings, due to the strong EM coupling between conductors' assembly 10 and receiving conductor 20.

Although the present invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. A near field power system, comprising:
(i) at least one alternating power signal source,
(ii) at least one continuous signal conductor configured to receive an electrical signal from said power signal source and further configured to be stretched along a path,
(iii) at least one continuous ground conductor configured to be in communication with a ground of said power signal source and further configured to be stretched along said path,
(iv) at least one receiving conductor configured to be mounted on at least one mobile platform,
wherein the continuous signal conductor is configured to be disposed in a predefined distance from the continuous ground conductor whereby a designated charging volume is formed, and a resonance within said charging volume creating an electromagnetic coupling between said continuous signal and ground conductors with the at least one receiving conductor occurs in a pre-defined frequencies within said charging volume without necessary overlapping or alignment between the conductors.

2. The system of claim 1, wherein the resonance within charging volume designates a constant and continuous EM coupling between the said continuous signal and ground conductors and the receiving conductor.

3. The system of claim 1, wherein the at least one alternating power signal source is a transmitter configured to generate such signal.

4. The system of claim 1, wherein the at least one alternating power signal source is in communication with the receiving conductor whereby the function of the other conductors is modified accordingly.

5. The system of claim 1, wherein the designated distance separating the continuous signal and ground conductors along the path determines the dimensions of the charging volume.

6. The system of claim 1, wherein the at least one mobile platform is configured to be charged through the receiving conductor by the constant EM coupling creating a wireless charging volume.

7. The system of claim 1, wherein the at least one mobile platform is stationary within the charging volume.

8. The system of claim 1, wherein the at least one continuous signal conductor is configured to be placed between at least two continuous ground conductors, and wherein said conductors are configured to be spaced by a designated distance along the path.

9. The system of claim 1, wherein the at least one continuous signal conductor and the at least one continuous ground conductor are configured to be mounted on ground level.

10. The system of claim 1, wherein the at least one continuous signal conductor and the at least one continuous ground conductor are configured to be mounted beneath ground level.

11. The system of claim 1, wherein the at least one continuous signal conductor and the at least one continuous ground conductor are configured to be mounted on a vertical surface.

12. The system of claim 1, wherein the at least one continuous signal conductor and the at least one continuous ground conductor are configured to be mounted on a moving object.

13. The system of claim 1, wherein the at least one continuous signal conductor and the at least one continuous ground conductor are configured to be made of a conductive material having a thickness of 50-150 micron.

14. The system of claim 1, wherein the at least one continuous signal conductor and/or the at least one continuous ground conductor are of an elongated sheet shape.

15. The system of claim 1, wherein the at least one continuous signal conductor and/or the at least one continuous ground conductor have circular cross-sections.

16. The system of claim 1, wherein the receiving conductor is mounted on a mobile platform and wherein the receiving conductor is configured to maintain a continuous EM coupling with the at least one continuous signal conductor and the at least one continuous ground conductor during operation or movement along the path.

17. The system of claim 1, wherein the receiving conductor is mounted on a mobile platform and maintains a constant and continuous EM coupling with the at least one continuous signal conductor and the at least one continuous ground conductor while moving near the path but not necessarily in alignment with the path.

18. The system of claim 1, wherein the receiving conductor is configured to maintain constant and continuous EM coupling with the at least one continuous signal conductor and the at least one continuous ground conductor as long as it remains within a charging volume.

19. The system of claim 16, wherein said operational constant and continuous EM coupling is maintained with the at least one continuous signal conductor and the at least one continuous ground conductor by a height control means.

20. The system of claim 1, wherein the at least one receiving conductor may be mounted on any section of the mobile platform.

21. The system of claim 1, wherein the mobile platform is an autonomous vehicle configured to move along the path.

22. The system of claim 21, wherein the autonomous vehicle is a logistic vehicle configured to move within an operational environment.

23. The system of claim 1, wherein the mobile platform is an electrical vehicle (EV) configured to keep full operability while charging.

24. The system of claim 1, wherein either the at least one continuous signal conductor, or the at least one continuous ground conductor are configured to have different dimensions along their length in order to provide adaptive resonance and EM coupling capabilities.

25. The system of claim 24, wherein the different dimensions are at least one non-parallel section forming a part of the at least one continuous signal conductor and/or the at least one continuous ground conductor.

26. The system of claim 1, wherein multiple sections of continuous signal conductors and continuous ground conductors are placed in a consecutive manner along the path.

27. The system of claim 1, wherein the EM resonance is creatable only when a mobile platform having a receiving conductor is present within a designated charging volume.

28. The system of claim 1, wherein multiple EM resonances are created for each of at least two mobile platforms having a receiving conductor and move along the path.

29. A method for using a near field power system, comprising the steps of:
(i) providing an alternating power signal produced by at least one transmitter;
(ii) communicating said alternating power signal to at least one continuous signal conductor while the at least one continuous ground conductor is in communication with the transmitter ground, wherein both conductors are configured to be stretched along a path and be disposed in predefined distance from each other, whereby a designated charging volume is formed;
(iii) providing at least one receiving conductor configured to be mounted on at least one mobile platform;
(iv) forming an electromagnetic (EM) resonance within said charging volume between the at least one continuous signal conductor together with at least one continuous ground conductor and the receiving conductor, in a pre-defined frequencies within said charging volume without necessary overlapping or alignment between the conductors;
(v) creating a constant and continuous EM coupling between the continuous signal together with the ground conductors and the receiving conductor.
